(19) United States
(12) Patent Application Publication
(10) Pub. No.: US 2026/0337113 A1
(43) Pub. Date: Oct. 29, 2026

(54) LOW-STRESS-SENSITIVITY HIGH-FREQUENCY MANGANESE-ZINC FERRITE MATERIAL, AND PREPARATION METHOD THEREFOR

(71) Applicant: HENGDIAN GROUP DMEGC MAGNETICS CO., LTD, Dongyang Jinhua, Zhejiang (CN)

(72) Inventors: Yong ZHU, Dongyang Jinhua, Zhejiang (CN); Yongping LI, Dongyang Jinhua, Zhejiang (CN); Jun XU, Dongyang Jinhua, Zhejiang (CN); Zhihong JIN, Dongyang Jinhua, Zhejiang (CN)

(21) Appl. No.: 18/995,826

(22) PCT Filed: Aug. 10, 2023
(86) PCT No.: PCT/CN2023/112106

§ 371 Date: Jan. 16, 2025

(30) Foreign Application Priority Data
Aug. 12, 2022 (CN) 202210967318.1

(51) Int. Cl. C04B 35/26; C04B 35/626; C04B 35/63; C04B 35/634; H01F 1/36

(52) U.S. Cl. CPC C04B 35/2658; C04B 35/6261; C04B 35/6303; C04B 35/63416; C04B 35/6342; H01F 1/36; C04B 2235/3208; C04B 2235/3232; C04B 2235/3251; C04B 2235/3274; C04B 2235/3275; C04B 2235/602; C04B 2235/606

(57) ABSTRACT

The present text discloses a low-stress-sensitivity high-frequency manganese-zinc ferrite material and a preparation method therefor. The low-stress-sensitivity high-frequency manganese-zinc ferrite material comprises: main components and additives; the main components comprise Fe₂O₃, ZnO and MnO; and the additives comprise Co₂O₃, CaCO₃, Nb₂O₅ and TiO₂. In the present application, the suitable main formula ratios reduce the magnetostriction coefficient of the material, reducing the stress sensitivity characteristics of the material; the suitable additive combination and addition amounts reduce material loss and improve material temperature properties; and a combination of low-temperature sintering and a special cooling curve reduce the grain size of the material, reduce the stress sensitivity and high-frequency loss of the material, and result in a high-frequency manganese-zinc ferrite material having low stress sensitivity and low loss.

### TECHNICAL FIELD

Examples of the present application belong to the field of magnetic core materials, for example, a high-frequency manganese-zinc ferrite material, and specially, relate to a low-stress-sensitive high-frequency manganese-zinc ferrite material and a preparation method therefor.

### BACKGROUND

Manganese-zinc ferrite materials, as basic materials of the modern electronic industry and information industry, are widely used in fields of electronics and communication as energy storage and conversion materials. As electronic components are developed towards humanization, miniaturization, and high-output power, the use frequency of MnZn ferrite magnetic cores gradually moves from low-frequency to high-frequency.

Therefore, many researchers have studied high-frequency MnZn ferrites and discovered many manufacturing processes and formulas of high-frequency MnZn ferrites. However, many application problems have been found during the use of high-frequency MnZn ferrite magnetic cores; for example, the magnetic permeability of high-frequency manganese-zinc ferrite cores with or without an applied external pressure is different, which affects the stability of its application.

CN102503396A discloses a high-frequency low-loss MnZn ferrite and a preparation method therefor, and the high-frequency low-loss MnZn ferrite comprises main materials: 50.2-54 mol % of Fe₂O₃, 36-42 mol % of MnO, and a remainder of ZnO; auxiliary materials: 0.25-0.35 wt % of CaCO₃, 0.04-0.6 wt % of V₂O₅, and 0.02-0.03 wt % of Nb₂O₅. Meanwhile, CN102503396A also discloses a preparation method for the high-frequency low-loss MnZn ferrite, comprising a preparation of a pre-sintered material, a preparation of a granular material, and a process of low-temperature sintering. The high-frequency low-loss MnZn ferrite disclosed in this patent has a power consumption of less than or equal to 200 mW/cm3 at 100 °C, 1 MHz, and 30 mT.

CN104108925A discloses a preparation method for a high-frequency manganese-zinc ferrite material, raw materials of the high-frequency manganese-zinc ferrite material comprises: Fe₂O₃, ZnO, MnO, SiO₂, CaCO₃, V₂O₅, TiO₂, and ZrO₂, wherein a molar ratio of Fe₂O₃:MnO:ZnO is (53-56):(38-41):(5-8), and based on a total mass of Fe₂O₃, ZnO, and MnO, mass fractions of SiO₂, CaCO₃, V₂O₅, TiO₂, and ZrO₂ are 20-70 ppm, 100-800 ppm, 100-500 ppm, 200-2400 ppm, and 100-500 ppm, respectively. The high-frequency low-loss MnZn ferrite disclosed in this patent has a power consumption of less than or equal to 330 mW/cm3 at 100 °C, 1 MHz, and 50 mT.

CN113277840A discloses a high-frequency, high-working magnetic flux density, and low-loss manganese-zinc ferrite, and a preparation method therefor. The high-frequency, high-working magnetic flux density, and low-loss manganese-zinc ferrite is composed of a main component and an auxiliary component. The main component is composed of, in an oxide form, 54.55-55.20 mol % of Fe₂O₃, 4.0-5.0 mol % of ZnO, and a remainder of MnO. Calculated based on the weight of the main component, an auxiliary component I comprises 0.01-0.06 wt % of Nb₂O₅, 0.15-0.30 wt % of C0203, 0.05-0.15 wt % of CaCO₃, and 0.01-0.04 wt % of V₂O₅; and an auxiliary component II is composed of at least two of 0.01-0.05 wt % of NiO, 0.005-0.015 wt % of SiO₂, and 0.01-0.05 wt % of MoO₃. The sintering temperature is 1060-1100 °C, the crushing particle size is 0.4-0.8 μm, and the material provided by this patent has a power consumption of less than 800 kW/m³ at 25-100 °C, 1 MHz and 100 mT.

The manganese-zinc ferrite materials provided in the above patents all have the characteristic of high-frequency, but none of them disclose the magnetic permeability change of the high-frequency manganese-zinc ferrite material after applied with an external force. However, the change of the magnetic permeability will affect the application of the high-frequency manganese-zinc ferrite material. Therefore, it is of great theoretical and practical significance to develop a high-frequency manganese-zinc ferrite material with low stress sensitivity and low loss.

### SUMMARY

The following is a summary of the subject described herein. This summary is not intended to limit the protection scope of the claims.

Examples of the present application provide a low-stress-sensitive high-frequency manganese-zinc ferrite material and a preparation method therefor. In the present application, by appropriate main formula proportions, the magnetostrictive coefficient of the material is decreased, and the stress sensitivity of the material is reduced; by an appropriate combination of additives and an appropriate amount of additives, the material loss is reduced, and the temperature characteristic of the material is improved; and a low-temperature sintering process is coordinated with a special cooling curve to reduce the grain size of the material, and reduce the stress sensitivity and the high-frequency loss of the material, so that the high-frequency manganese-zinc ferrite material with low stress sensitivity and low loss is prepared.

In a first aspect, an example of the present application provides a low-stress-sensitive high-frequency manganese-zinc ferrite material, and the low-stress-sensitive high-frequency manganese-zinc ferrite material comprises a main component and an additive;
the main component comprises Fe₂O₃, ZnO, and MnO;
the additive comprises Co₂O₃, CaCO₃, Nb₂O₅, and TiO₂.

In the present application, by appropriate main formula proportions, the magnetostrictive coefficient of the material is decreased, and the stress sensitivity of the material is reduced; by an appropriate combination of additives and an appropriate amount of additives, the material loss is reduced, and the temperature characteristic of the material is improved.

The auxiliary additives selected in the present application have the following effects: Co³⁺ in the Co₂O₃ has a positive K₁ (magnetocrystalline anisotropy constant) which compensates for the negative K₁ value of the manganese-zinc ferrite, reducing the hysteresis loss, and improving the temperature performance of the material;
the CaCO₃ has an effect on the material of increasing the grain boundary resistivity and reducing the eddy current loss;
the Nb₂O₅ can promote a densification process during sintering process, improving the grain uniformity, reducing pores, reducing the hysteresis loss, and forming a high resistivity layer at the grain boundary to reduce the eddy current loss of the material; and the TiO₂ can form a Ti⁴⁺—Fe²⁺ ion pair locally in the material to inhibit the electronic transition between Fe²⁺ and Fe³⁺, improve the resistance at room temperature inside the grain, reduce the eddy current loss at room temperature, and provide additional cation holes for the diffusion of Nb₂O₅, further promoting the effect of Nb₂O₅.

Preferably, by percentage relative to a total mole amount of the main component, raw materials of the main component comprise: 52-53 mol % of Fe₂O₃, which can be, for example, 52 mol %, 52.2 mol %, 52.4 mol %, 52.6 mol %, 52.8 mol %, or 53 mol %, but the proportion is not limited to the listed values, and other unlisted values within the numerical range are also applicable; 6-7 mol % of ZnO, which can be, for example, 6 mol %, 5.2 mol %, 6.4 mol %, 6.6 mol %, 6.8 mol %, or 7 mol %, but the proportion is not limited to the listed values, and other unlisted values within the numerical range are also applicable; and the remainder is MnO.

Preferably, by percentage relative to a total mass of the main component, the additive comprises:
Co₂O₃ 1500-3000 ppm;
CaCO₃ 600-1000 ppm;
Nb₂O₅ 100-300 ppm; and
TiO₂ 1000-3000 ppm.

The Co₂O₃ has a content of 1500-3000 ppm, which can be, for example, 1500 ppm, 2000 ppm, 2500 ppm, or 3000 ppm, but the content is not limited to the listed values, and other unlisted values within the numerical range are also applicable; the CaCO₃ has a content of 600-1000 ppm, which can be, for example, 600 ppm, 700 ppm, 800 ppm, 900 ppm, or 1000 ppm, but the content is not limited to the listed values, and other unlisted values within the numerical range are also applicable; the Nb₂O₅ has a content of 100-300 ppm, which can be, for example, 100 ppm, 150 ppm, 200 ppm, 250 ppm, or 300 ppm, but the content is not limited to the listed values, and other unlisted values within the numerical range are also applicable; the TiO₂ has a content of 1000-3000 ppm, which can be, for example, 1000 ppm, 1500 ppm, 2000 ppm, 2500 ppm, or 3000 ppm, but the content is not limited to the listed values, and other unlisted values within the numerical range are also applicable.

In a second aspect, an example of the present application provides a preparation method for the low-stress-sensitive high-frequency manganese-zinc ferrite material according to the first aspect, and the preparation method comprises the following steps:
(1) mixing the main component (Fe₂O₃, ZnO, and MnO) according to a formula amount, and then performing primary fine-grinding, drying, and pre-sintering sequentially to obtain a pre-sintered material;
(2) mixing an additive and the pre-sintered material obtained in step (1), and performing secondary fine-grinding and drying to obtain a fine-ground powder material; and
(3) subjecting the fine-ground powder material in step (2) to screening, granulation, molding, and sintering sequentially to obtain the low-stress-sensitive high-frequency manganese-zinc ferrite material.

In the preparation process of the present application, the main component is first mixed evenly, and then subjected to pre-sintering to grow spinel structure partially, and then the pre-sintered product is added with an appropriate additive, and subjected to secondary ball-milling to endow the powder with the appropriate particle size range. In the present application, the main component and the additive cannot be subjected to one-time mixing; otherwise, after the main component and the additive are pre-sintered, the grain will grow excessively and be hard to grind to fineness; in addition, one-time mixing will cause the problem of an inaccurate content of the additive, and the content of each component of the additive can be accurate by the method in the present application.

Preferably, the process of the primary fine-grinding in step (1) comprises: adding the main component and water into a fine mill for the primary fine-grinding.

Preferably, a mass ratio of the main component to the water is 1:(1.2-2.5), which can be, for example, 1:1.2, 1:1.4, 1:1.6, 1:1.8, 1:2, 1:2.2, or 1:2.5; however, the mass ratio is not limited to the listed values, and other unlisted values within the numerical range are also applicable.

Preferably, the primary fine-grinding in step (1) is performed for a period of 1-3 h, which can be, for example, 1 h, 1.4 h, 1.8 h, 2.2 h, 2.6 h, or 3 h; however, the period is not limited to the listed values, and other unlisted values within the numerical range are also applicable.

Preferably, the pre-sintering in step (1) is performed at a temperature of 750-850 °C, which can be, for example, 750 °C, 760 °C, 770 °C, 780 °C, 790 °C, 800 °C, 810 °C, 820 °C, 830 °C, 840 °C, or 850 °C; however, the temperature is not limited to the listed values, and other unlisted values within the numerical range are also applicable.

Preferably, the pre-sintering in step (1) is performed for a period of 1-3 h, which can be, for example, 1 h, 1.4 h, 1.8 h, 2.2 h, 2.6 h, or 3 h; however, the period is not limited to the listed values, and other unlisted values within the numerical range are also applicable.

Preferably, the pre-sintering in step (1) is performed in an air atmosphere.

The pre-sintering temperature of the present application is required to be in the range of 750-850 °C. If the pre-sintering temperature is too high, the grain grows too large, and is not easy to be ground to obtain a suitable particle size range within a specific time; if the pre-sintering temperature is too low, the powder activity is too high, the grain size after the sintering has poor uniformity, and the product has more pores and poor performance.

Preferably, the additive in step (2) comprises Co₂O₃, CaCO₃, Nb₂O₅, and TiO₂.

Preferably, an additive amount of Co₂O₃ in the additive is 1500-3000 ppm relative to a total mass of the main component, which can be, for example, 1500 ppm, 2000 ppm, 2500 ppm, or 3000 ppm; however, the additive amount is not limited to the listed values, and other unlisted values within the numerical range are also applicable.

Preferably, an additive amount of CaCO₃ in the additive is 600-1000 ppm relative to a total mass of the main component, which can be, for example, 600 ppm, 800 ppm, or 1000 ppm; however, the additive amount is not limited to the listed values, and other unlisted values within the numerical range are also applicable.

Preferably, an additive amount of Nb₂O₅ in the additive is 100-300 ppm relative to a total mass of the main component, which can be, for example, 100 ppm, 150 ppm, 200 ppm, 250 ppm, or 300 ppm; however, the additive amount is not limited to the listed values, and other unlisted values within the numerical range are also applicable.

Preferably, an additive amount of TiO₂ in the additive is 1000-3000 ppm relative to a total mass of the main component, which can be, for example, 1000 ppm, 1500 ppm, 2000 ppm, 2500 ppm, or 3000 ppm; however, the additive amount is not limited to the listed values, and other unlisted values within the numerical range are also applicable.

Preferably, the secondary fine-grinding in step (2) is performed for a period of 2-4 h, which can be, for example, 2 h, 2.4 h, 2.8 h, 3.2 h, 3.6 h, or 4 h; however, the period is not limited to the listed values, and other unlisted values within the numerical range are also applicable.

Preferably, the fine-ground powder material in step (2) has a particle size X50 of 0.8-1.2 μm, which can be, for example, 0.8 μm, 0.9 μm, 1 μm, 1.1 μm, or 1.2 μm; however, the particle size is not limited to the listed values, and other unlisted values within the numerical range are also applicable.

Preferably, a screen used for the screening in step (3) has a size of 30-80 mesh, which can be, for example, 30 mesh, 40 mesh, 50 mesh, 60 mesh, 70 mesh, or 80 mesh; however, the size is not limited to the listed values, and other unlisted values within the numerical range are also applicable.

Preferably, in the granulation in step (3), a granulating agent is added.

Preferably, the granulating agent comprises PVA and/or PVB.

Preferably, an additive amount of the granulating agent is 8-15% relative to a mass of the fine-ground powder material in step (2), which can be, for example, 8%, 9%, 10%, 11%, 12%, 13%, 14%, or 15%; however, the additive amount is not limited to the listed values, and other unlisted values within the numerical range are also applicable.

Preferably, the molding in step (3) comprises: preparing a product obtained after the granulation into a standard ring blank.

Preferably, the standard ring blank has a size of 12.5 mm×7.5 mm×7 mm.

Preferably, a process of the sintering in step (3) comprises: under an atmosphere with equilibrium oxygen partial pressure, heating the standard ring blank to a first temperature and holding the temperature, then cooling to a second temperature at a first cooling rate and holding the temperature, and finally cooling to a third temperature at a second cooling rate.

Preferably, the heating is performed at a heating rate of 1-3 °C/min, which can be, for example, 1 °C/min, 1.5 °C/min, 2 °C/min, 2.5 °C/min, or 3 °C/min; however, the heating rate is not limited to the listed values, and other unlisted values within the numerical range are also applicable.

Preferably, the first temperature is 950-1100 °C, which can be, for example, 950 °C, 1000 °C, 1020 °C, 1040 °C, 1060 °C, 1080 °C, or 1100 °C; however, the first temperature is not limited to the listed values, and other unlisted values within the numerical range are also applicable.

Preferably, the first temperature is held for a period of 3-7 h, which can be, for example, 3 h, 3.5 h, 4 h, 4.5 h, 5 h, 5.5 h, 6 h, 6.5 h, or 7 h; however, the period is not limited to the listed values, and other unlisted values within the numerical range are also applicable.

Preferably, the first cooling rate is 2.5-5 °C/min, which can be, for example, 2.5 °C/min, 3 °C/min, 3.5 °C/min, 4 °C/min, 4.5 °C/min, or 5 °C/min; however, the first cooling rate is not limited to the listed values, and other unlisted values within the numerical range are also applicable.

Preferably, the second temperature is 250-300 °C, which can be, for example, 250 °C, 260 °C, 270 °C, 280 °C, 290 °C, or 300 °C; however, the second temperature is not limited to the listed values, and other unlisted values within the numerical range are also applicable.

Preferably, the second temperature is held for a period of 3-5 h, which can be, for example, 3 h, 3.5 h, 4 h, 4.5 h, or 5 h; however, the period is not limited to the listed values, and other unlisted values within the numerical range are also applicable.

Preferably, the second cooling rate is 0.1-0.5 °C/min, which can be, for example, 0.1 °C/min, 0.2 °C/min, 0.3 °C/min, 0.4 °C/min, or 0.5 °C/min; however, the second cooling rate is not limited to the listed values, and other unlisted values within the numerical range are also applicable.

Preferably, the third temperature is 40-80 °C, which can be, for example, 40 °C, 50 °C, 60 °C, 70 °C, or 80 °C; however, the third temperature is not limited to the listed values, and other unlisted values within the numerical range are also applicable; preferably, the third temperature is 50-70 °C.

The sintering process in the present application: in the heating process, a reaction process of the system at 800 °C is: Mn₂O₃-MnMn₂O₄+O₂;
a reaction process in the heating process from 850 °C to the first temperature is: MnMn₂O₄+Fe₂O₃→MnFe₂O₄+O₂; and
a reaction process in the temperature-holding process is: Fe₂O₃—FeFe₂O₄+O₂.

In the sintering process, the oxygen content is different, the FeFe₂O₄ content is different, the K₁ (magnetocrystalline anisotropy constant) of the material is different, and the performance is different; for the staged cooling process, in the first cooling process, according to a formula of equilibrium oxygen partial pressure, the oxygen partial pressure for the temperature point of each stage is set, so that the FeFe₂O₄ in the manganese-zinc ferrite is maintained at a required content, and in the second cooling process, the Co²⁺ ion in the ferrite is from a metastable state to a stable low energy level, reducing the material loss.

As a preferred technical solution of the present application, the preparation method for the low-stress-sensitive high-frequency manganese-zinc ferrite material according to the second aspect in the present application comprises the following steps:
(1) mixing the main component (Fe₂O₃, ZnO, and MnO) according to a formula amount, and then mixing the main component with water at a mass ratio of 1:(1.2-2.5), performing primary fine-grinding for 1-3 h, and drying, and then performing pre-sintering at a temperature of 750-850 °C in an air atmosphere for 1-3 h to obtain a pre-sintered material;
(2) mixing an additive with the pre-sintered material obtained in step (1), and performing secondary fine-grinding for 2-4 h, and drying to obtain a fine-ground powder material with a particle size X50 of 0.8-1.2 μm;
relative to a total mass of the main component, the additive comprises: 1500-3000 ppm of C0203, 600-1000 ppm of CaCO₃, 100-300 ppm of Nb₂O₅, and 1000-3000 ppm of TiO₂; and
(3) screening the fine-ground powder material in step (2) with a 30-80 mesh screen, and performing granulation and molding to obtain a standard ring blank with a size of 12.5 mm×7.5 mm×7 mm, and sintering to obtain the low-stress-sensitive high-frequency manganese-zinc ferrite material;
a process of the sintering comprises: under an atmosphere with equilibrium oxygen partial pressure, heating the standard ring blank to 950-1100 °C at a heating rate of 1-3 °C/min and holding the temperature for 3-7 h, and then cooling to 250-300 °C at a cooling rate of 2.5-5 °C/min, holding the temperature for 3-5h, and finally cooling to 40-80 °C at a cooling rate of 0.1-0.5 °C/min.

The numerical ranges in the present application comprise not only the above-listed point values, but also any unlisted point value within the above numerical ranges, and for reasons of space and brevity, the specific point values comprised in the ranges will not be listed exhaustively in the present application.

Compared with the related art, the present application has the following beneficial effects.
(1) In the examples of the present application, by appropriate main formula proportions, the magnetostrictive coefficient of the material is decreased, and the stress sensitivity of the material is reduced;
(2) In the examples of the present application, by an appropriate combination of the additives and an appropriate amount of additives, the material loss is reduced, and the temperature characteristic of the material is improved; and
(3) The low-stress-sensitive high-frequency manganese-zinc ferrite material provided in the examples of the present application has a low stress sensitivity, and the ferrite material has a change of magnetic permeability of less than 5% after being applied with a pressure of 10 MPa.

Other aspects will be appreciated upon reading and understanding the detailed description.

### DETAILED DESCRIPTION

The technical solutions of the present application are further illustrated by the following embodiments. Those skilled in the art should understand that the examples merely assist in understanding the present application, but should not be regarded as a specific limitation of the present application.

### Example 1

This example provides a low-stress-sensitive high-frequency manganese-zinc ferrite material, and a preparation method for the low-stress-sensitive high-frequency manganese-zinc ferrite material comprises the following steps:
(1) 52.4 mol % of Fe₂O₃, 6.8 mol % of ZnO, and a remainder of MnO were mixed, then mixed with water at a mass ratio of 1:1.5, subjected to primary fine-grinding for 1 h, dried, and then subjected to pre-sintering at a temperature of 750 °C in an air atmosphere for 3 h to obtain a pre-sintered material;
(2) an additive and the pre-sintered material obtained in step (1) were mixed, subjected to secondary fine-grinding for 2 h, and dried to obtain a fine-ground powder material with a particle size of X50 of 1 μm;
relative to a total mass of the main component, the additive comprises 3000 ppm of Co₂O₃, 1000 ppm of CaCO₃, 100 ppm of Nb₂O₅, and 2000 ppm of TiO₂; and
(3) the fine-ground powder material in step (2) was screened with a 60-mesh screen, granulated, and molded to a standard ring blank with a size of 12.5 mm×7.5 mm×7 mm, and sintering was performed to obtain the low-stress-sensitive high-frequency manganese-zinc ferrite material;
a process of the sintering comprised: under an atmosphere with equilibrium oxygen partial pressure, the standard ring blank was heated to 1060 °C at a heating rate of 1.5 °C/min, and subjected to heat preservation for 7 h, and then cooled to 280 °C at a cooling rate of 2.8 °C/min, and subjected to heat preservation for 3 h, and finally cooled to 50 °C at a cooling rate of 0.1 °C/min.

### Example 2

This example provides a low-stress-sensitive high-frequency manganese-zinc ferrite material, and a preparation method for the low-stress-sensitive high-frequency manganese-zinc ferrite material comprises the following steps:
(1) 52 mol % of Fe₂O₃, 6 mol % of ZnO, and a remainder of MnO were mixed, then mixed with water at a mass ratio of 1:1.5, subjected to primary fine-grinding for 3 h, dried, and then subjected to pre-sintering at a temperature of 750 °C in an air atmosphere for 2 h to obtain a pre-sintered material;
(2) an additive and the pre-sintered material obtained in step (1) were mixed, subjected to secondary fine-grinding for 4 h, and dried to obtain a fine-ground powder with a particle size of X50 of 0.8 μm;
relative to a total mass of the main component, the additive comprises 1500 ppm of Co₂O₃, 600 ppm of CaCO₃, 300 ppm of Nb₂O₅, and 3000 ppm of TiO₂; and
(3) the fine-ground powder material in step (2) was screened with a 60-mesh screen, granulated, and molded to a standard ring blank with a size of 12.5 mm×7.5 mm×7 mm, and sintering was performed to obtain the low-stress-sensitive high-frequency manganese-zinc ferrite material;
a process of the sintering comprised: under an atmosphere with equilibrium oxygen partial pressure, the standard ring blank was heated to 950 °C at a heating rate of 1.5 °C/min, and subjected to heat preservation for 7 h, and then cooled to 300 °C at a cooling rate of 2.5 °C/min, and subjected to heat preservation for 3 h, and finally cooled to 80 °C at a cooling rate of 0.1 °C/min.

### Example 3

This example provides a low-stress-sensitive high-frequency manganese-zinc ferrite material, and a preparation method for the low-stress-sensitive high-frequency manganese-zinc ferrite material comprises the following steps:
(1) 53 mol % of Fe₂O₃, 7 mol % of ZnO, and a remainder of MnO were mixed, then mixed with water at a mass ratio of 1:1.5, subjected to primary fine-grinding for 1 h, dried, and then subjected to pre-sintering at a temperature of 850 °C in an air atmosphere for 1 h to obtain a pre-sintered material;
(2) an additive and the pre-sintered material obtained in step (1) were mixed, subjected to secondary fine-grinding for 2 h, and dried to obtain a fine-ground powder with a particle size of X50 of 1 μm;
relative to a total mass of the main component, the additive comprises 3000 ppm of Co₂O₃, 1000 ppm of CaCO₃, 100 ppm of Nb₂O₅, and 1000 ppm of TiO₂; and
(3) the fine-ground powder material in step (2) was screened with a 60-mesh screen, granulated, and molded to a standard ring blank with a size of 12.5 mm×7.5 mm×7 mm, and sintering was performed to obtain the low-stress-sensitive high-frequency manganese-zinc ferrite material;
a process of the sintering comprised: under an atmosphere with equilibrium oxygen partial pressure, the standard ring blank was heated to 1100 °C at a heating rate of 1.5 °C/min, and subjected to heat preservation for 7 h, and then cooled to 250 °C at a cooling rate of 2.8 °C/min, and subjected to heat preservation for 3 h, and finally cooled to 40 °C at a cooling rate of 0.1 °C/min.

### Example 4

This example provides a low-stress-sensitive high-frequency manganese-zinc ferrite material, and a preparation method for the low-stress-sensitive high-frequency manganese-zinc ferrite material differs from Example 1 only in that the first temperature of the sintering in step (3) in this example was changed to 1135 °C.

### Example 5

This example provides a low-stress-sensitive high-frequency manganese-zinc ferrite material, and a preparation method for the low-stress-sensitive high-frequency manganese-zinc ferrite material differs from Example 1 only in that the first temperature of the sintering in step (3) in this example was changed to 1100 °C.

### Example 6

This example provides a low-stress-sensitive high-frequency manganese-zinc ferrite material, and a preparation method for the low-stress-sensitive high-frequency manganese-zinc ferrite material differs from Example 1 only in that the second cooling rate of the sintering in step (3) in this example was changed to 1 °C/min.

### Example 7

This example provides a low-stress-sensitive high-frequency manganese-zinc ferrite material, and a preparation method for the low-stress-sensitive high-frequency manganese-zinc ferrite material differs from Example 1 only in that the content of the main component in step (1) in this example was changed to: 52.5 mol % of Fe₂O₃, 6.3 mol % of ZnO, and a remainder of MnO.

### Example 8

This example provides a low-stress-sensitive high-frequency manganese-zinc ferrite material, and a preparation method for the low-stress-sensitive high-frequency manganese-zinc ferrite material differs from Example 1 only in that the content of the additive in step (2) in this example was changed to: 2000 ppm of Co₂O₃, 1000 ppm of CaCO₃, 100 ppm of Nb₂O₅, and 1000 ppm of TiO₂, relative to a total mass of the main component.

### Comparative Example 1

This comparative example provides a low-stress-sensitive high-frequency manganese-zinc ferrite material, and a preparation method for the low-stress-sensitive high-frequency manganese-zinc ferrite material differs from Example 1 only in that the content of the ZnO in step (1) in this comparative example was changed to 5 mol %.

### Comparative Example 2

This comparative example provides a low-stress-sensitive high-frequency manganese-zinc ferrite material, and a preparation method for the low-stress-sensitive high-frequency manganese-zinc ferrite material differs from Example 1 only in that the Co₂O₃ in the additive in step (2) in this comparative example was omitted.

### Comparative Example 3

This comparative example provides a low-stress-sensitive high-frequency manganese-zinc ferrite material, and a preparation method for the low-stress-sensitive high-frequency manganese-zinc ferrite material differs from Example 1 only in that the TiO₂ in the additive in step (2) in this comparative example was omitted.

### Comparative Example 4

This comparative example provides a low-stress-sensitive high-frequency manganese-zinc ferrite material, and a preparation method for the low-stress-sensitive high-frequency manganese-zinc ferrite material differs from Example 1 only in that the additive amount of the C0203 in the additive in step (2) in this comparative example was changed to 3500 ppm.

### Comparative Example 5

This comparative example provides a low-stress-sensitive high-frequency manganese-zinc ferrite material, and a preparation method for the low-stress-sensitive high-frequency manganese-zinc ferrite material differs from Example 1 only in that the additive amount of the TiO₂ in the additive in step (2) in this comparative example was changed to 3500 ppm.

The low-stress-sensitive high-frequency manganese-zinc ferrite materials provided in Examples 1-8 and Comparative Examples 1-5 were tested for performance; the details are described below.

The low-stress-sensitive high-frequency manganese-zinc ferrite material was placed on SY8218 test equipment, and measured for its loss under conditions of 1 MHz, 50 mT, and T=25 °C/100 °C/120 °C; the magnetic permeability was measured at 10 kHz, 0.25 V, and 25 °C, and the magnetic permeability was also measured at 10 kHz, 0.25 V, 25 °C, and an applied uniform pressure of 10 Mpa; the results are shown in Table 1.

TABLE 1

| | Loss (kW/m³) | | | μi (1000 kHz, 0.25 mT) | | Change |
|---|---|---|---|---|---|---|
| | 25 °C | 100 °C | 120 °C | 0 MPa | 10 MPa | proportion (%) |
| Example 1 | 90 | 101 | 120 | 1204 | 1238 | 2.8 |
| Example 2 | 79 | 123 | 145 | 1276 | 1321 | 3.5 |
| Example 3 | 149 | 121 | 131 | 1212 | 1243 | 2.5 |
| Example 4 | 168 | 151 | 209 | 1213 | 1290 | 6.3 |
| Example 5 | 99 | 130 | 162 | 1243 | 1271 | 2.2 |
| Example 6 | 189 | 154 | 191 | 1200 | 1241 | 3.4 |
| Example 7 | 107 | 105 | 130 | 1073 | 1112 | 3.6 |
| Example 8 | 113 | 106 | 131 | 1198 | 1230 | 2.7 |
| Comparative | 103 | 100 | 123 | 831 | 941 | 13.2 |
| Example 1 | | | | | | |
| Comparative | 241 | 212 | 253 | 1231 | 1264 | 2.6 |
| Example 2 | | | | | | |
| Comparative | 201 | 126 | 140 | 1204 | 1235 | 2.6 |
| Example 3 | | | | | | |
| Comparative | 160 | 155 | 189 | 1132 | 1174 | 3.7 |
| Example 4 | | | | | | |
| Comparative | 96 | 131 | 185 | 1163 | 1221 | 4.9 |
| Example 5 | | | | | | |

Table 1 shows the following:
(1) it can be seen from the analysis of Example 1 and Comparative Example 1 that in the ferrite material, when the ZnO content is too low, the overall magnetic permeability is decreased, and the effect of stress on the magnetic permeability is increased;
(2) it can be seen from the analysis of Example 1 and Comparative Example 2 that the lack of the Co₂O₃ additive will cause a higher overall power consumption of the material;
(3) it can be seen from the analysis of Example 1 and Comparative Example 3 that the lack of the TiO₂ additive will cause a higher power consumption of the material, especially the room temperature loss;
(4) it can be seen from the analysis of Example 1 and Example 4 that if the sintering temperature is too high, the overall magnetic permeability will be increased, the effect of stress on magnetic permeability will be increased, and the overall power consumption of the material will be worse;
(5) it can be seen from the analysis of Example 1 and Example 6 that during the sintering process, if the temperature drops down quickly in the cooling stage, the overall power consumption of the material is worse;
(6) it can be seen from the analysis of Example 1 and Comparative Example 4 that the excessive addition of C0203 will cause an overall degradation in the power consumption of the material and a decrease in magnetic permeability; and
(7) it can be seen from the analysis of Example 1 and Comparative Example 5 that the excessive addition of TiO₂ will cause a degradation in the high-temperature power consumption of the material, a decrease in magnetic permeability, and poor stress performance.

In summary, for the low-stress-sensitive high-frequency manganese-zinc ferrite material provided in the present application, by appropriate main formula proportions, the magnetostrictive coefficient of the material is decreased, and the stress sensitivity of the material is reduced; by an appropriate combination of additives and an appropriate amount of additives, the material loss is reduced, and the temperature characteristic of the material is improved; and the ferrite material has a change of magnetic permeability of less than 5% after being applied with a pressure of 10 MPa.

The objects, technical solutions, and beneficial effects in the present application are further illustrated in detail by the above examples. It should be understood that the above are only specific examples of the present application, and are not intended to limit the present application, and any modifications, equivalent substitutions, and improvements made within the spirit and principle of the present application shall fall within the scope of the claims of the present application

1. A low-stress-sensitive high-frequency manganese-zinc ferrite material, which comprises a main component and an additive;
the main component comprises Fe₂O₃, ZnO, and MnO;
the additive comprises Co₂O₃, CaCO₃, Nb₂O₅, and TiO₂.

2. The low-stress-sensitive high-frequency manganese-zinc ferrite material according to claim 1, wherein by percentage relative to a total mole amount, raw materials of the main component comprise: 52-53 mol % of Fe₂O₃, 6-7 mol % of ZnO, and a remainder of MnO.

3. The low-stress-sensitive high-frequency manganese-zinc ferrite material according to claim 1, wherein by percentage relative to a total mass of the main component, the additive comprises:
Co₂O₃
1500-3000 ppm;
CaCO₃
600-1000 ppm;
Nb₂O₅
100-300 ppm; and
TiO₂
1000-3000 ppm.

4. A preparation method for the low-stress-sensitive high-frequency manganese-zinc ferrite material according to claim 1, comprising the following steps:
(1) mixing main component Fe₂O₃, ZnO, and MnO according to a formula amount, and then performing primary fine-grinding, drying, and pre-sintering sequentially to obtain a pre-sintered material;
(2) mixing an additive and the pre-sintered material obtained in step (1), and performing secondary fine-grinding and drying to obtain a fine-ground powder material; and
(3) subjecting the fine-ground powder material in step (2) to screening, granulation, molding, and sintering sequentially to obtain the low-stress-sensitive high-frequency manganese-zinc ferrite material.

5. The preparation method according to claim 4, wherein the primary fine-grinding in step (1) comprises: adding the main component and water into a fine mill for the primary fine-grinding.

6. The preparation method according to claim 5, wherein a mass ratio of the main component to the water is 1:(1.2-2.5).

7. The preparation method according to claim 4, wherein the primary fine-grinding in step (1) is performed for a period of 1-3 h.

8. The preparation method according to claim 4, wherein the pre-sintering in step (1) is performed at a temperature of 750-850 °C.

9. The preparation method according to claim 4, wherein the pre-sintering in step (1) is performed for a period of 1-3 h;
preferably, the pre-sintering in step (1) is performed in an air atmosphere.

10. The preparation method according to claim 4, wherein the additive in step (2) comprises Co₂O₃, CaCO₃, Nb₂O₅, and TiO₂;
preferably, an additive amount of Co₂O₃ in the additive is 1500-3000 ppm relative to a total mass of the main component;
preferably, an additive amount of CaCO₃ in the additive is 600-1000 ppm relative to a total mass of the main component;
preferably, an additive amount of Nb₂O₅ in the additive is 100-300 ppm relative to a total mass of the main component;
preferably, an additive amount of TiO₂ in the additive is 1000-3000 ppm relative to a total mass of the main component.

11. The preparation method according to claim 4, wherein the secondary fine-grinding in step (2) is performed for a period of 2-4 h;
preferably, the fine-ground powder material in step (2) has a particle size X50 of 0.8-1.2 μm.

12. The preparation method according to claim 4, wherein a screen used for the screening in step (3) has a size of 30-80 mesh;
preferably, in the granulation of step (3), a granulating agent is added;
preferably, the granulating agent comprises PVA and/or PVB;
preferably, an additive amount of the granulating agent is 8-15% relative to a mass of the fine-ground powder material in step (2);
preferably, the molding in step (3) comprises: preparing a product obtained after the granulation into a standard ring blank;
preferably, the standard ring blank has a size of 12.5 mm×7.5 mm×7 mm.

13. The preparation method according to claim 4, wherein the sintering in step (3) comprises: heating the standard ring blank to a first temperature, holding the temperature and introducing a certain amount of oxygen at the same time, and under an atmosphere with equilibrium oxygen partial pressure, cooling to a second temperature at a first cooling rate, holding the temperature, and finally cooling to a third temperature at a second cooling rate;
preferably, the heating is performed at a heating rate of 1-3 °C/min;
preferably, the first temperature is 950-1100 °C;
preferably, the first temperature is held for a period of 3-7 h;
preferably, the first cooling rate is 2.5-5 °C/min;
preferably, the second temperature is 250-300 °C;
preferably, the second temperature is held for a period of 3-5 h;
preferably, the second cooling rate is 0.1-0.5 °C/min;
preferably, the third temperature is 40-80 °C, preferably, 50-70 °C.

14. The preparation method according to claim 4, comprising the following steps:
(1) mixing main component Fe₂O₃, ZnO, and MnO according to a formula amount, and then mixing the main component with water at a mass ratio of 1:(1.2-2.5), performing primary fine-grinding for 1-3 h, and drying, and then performing pre-sintering at a temperature of 750-850 °C in an air atmosphere for 1-3 h to obtain a pre-sintered material;
(2) mixing an additive with the pre-sintered material obtained in step (1), and performing secondary fine-grinding for 2-4 h, and drying to obtain a fine-ground powder material with a particle size X50 of 0.8-1.2 μm;
wherein relative to a total mass of the main component, the additive comprises: 1500-3000 ppm of Co₂O₃, 600-1000 ppm of CaCO₃, 100-300 ppm of Nb₂O₅, and 1000-3000 ppm of TiO₂; and
(3) screening the fine-ground powder material in step (2) with a 30-80 mesh screen, and performing granulation and molding to obtain a standard ring blank with a size of 12.5 mm×7.5 mm×7 mm, and performing sintering to obtain the low-stress-sensitive high-frequency manganese-zinc ferrite material;
the sintering comprises: under an atmosphere with equilibrium oxygen partial pressure, heating the standard ring blank to 950-1100 °C at a heating rate of 1-3 °C/min, holding the temperature for 3-7 h, and then cooling to 250-300 °C at a cooling rate of 2.5-5 °C/min, holding the temperature for 3-5h, and finally cooling to 40-80 °C at a cooling rate of 0.1-0.5 °C/min.
